(19) United States
(12) Patent Application Publication
(10) Pub. No.: US 2024/0263951 A1
(43) Pub. Date: Aug. 8, 2024

(54) UTILIZING TRANSITION TIMES TO INTELLIGENTLY SELECT TRANSITION LOCATIONS FOR AUTONOMOUS VEHICLES

(71) Applicant: Lyft, Inc., San Francisco, CA (US)

(72) Inventors: Jeffrey Scott Breudecheck, San Francisco, CA (US); Thomas Jean-Pierre Nicolas Francois, Chicago, IL (US)

(21) Appl. No.: 18/163,562

(22) Filed: Feb. 2, 2023

(51) Int. Cl. G01C 21/34; G06Q 10/02; G06Q 50/30

(52) U.S. Cl. CPC G01C 21/3438; G01C 21/3453; G06Q 10/02; G06Q 50/40

(57) ABSTRACT

This disclosure describes an AV transition location system that can utilize computer implemented models to analyze updates from provider devices and requester devices, determine transition times for a variety of locations within various geographic areas, and intelligently select transition locations for autonomous vehicles or other provider devices based on the transition times. In particular, in one or more embodiments the disclosed systems utilize geohash mapping combined with provider device telematic data to establish a measure of pickups that satisfy transition time characteristics in given geographic areas. Depending on unique features required by the provider devices, the disclosed systems can provide a subset of preferred pickup locations to accurately and efficiently navigate autonomous devices.

### BACKGROUND

Recent years have seen significant developments in on-demand transportation systems that utilize mobile devices to coordinate across computer networks. Indeed, the proliferation of web and mobile applications has enabled requesting devices to utilize on-demand ride selection systems to coordinate across computer networks to initiate transportation from one geographic location to another and coordinate appropriate pickup or dropoff locations between provider devices and requester devices. For instance, conventional transportation network systems can determine geographic locations of provider devices and requester devices, generate digital matches between provider devices and requester devices, and further track, analyze, and manage pick-up, transportation, and drop-off routines through digital transmissions across computer networks. Despite these recent advances, however, conventional transportation network systems continue to exhibit a number of drawbacks and deficiencies, particularly with regard to implementations for autonomous vehicle (or “AV”) provider devices.

For example, conventional systems and implementing computing devices suffer from significant operational and accuracy problems when determining pickup or dropoff locations in certain geographic areas. For example, intersections, event venues, or otherwise congested areas often include few AV-accessible pickup or dropoff locations within the nearby geographic region. Moreover, autonomous vehicles often have restricted access to certain areas, introducing ambiguity as to appropriate pickup or dropoff locations and the proximity of requester devices to appropriate locations. These complications make many conventional approaches to locating, identifying, and matching autonomous vehicle provider devices and requester devices to pickup or dropoff locations ineffective. For example, conventional systems will often assign provider devices to inaccessible pickup or dropoff locations or at incompatible roadways due to the inaccuracy of location and identification technologies.

These technical problems also undermine the flexibility and functional capacity of conventional systems. For example, in addition to the difficulty of identifying and locating acceptable pickup or dropoff locations, the unique features of identifying locations for autonomous vehicles also inhibits effective coordination between provider devices and requester devices. To illustrate, requester devices within congested geographic areas are often located within common geographical areas, such as building access points, which provider devices approach along designated roadway entrances or exits. Accordingly, conventional systems within congested regions often function under a rigid pickup/dropoff location selection model while relying on providers and requesters to coordinate on detailed, final location selection. However, unlike conventional driver systems, autonomous vehicles generally lack the flexibility to coordinate effectively with requester devices in making in-the-moment decisions to deviate from a rigid location selection in response to contextual features. Moreover, conventional systems utilize the same pickup/dropoff location selection approach regardless of the type of provider device, the availability of appropriate pickup or dropoff locations or the specialized requirements of autonomous vehicles. This rigid approach, however, undermines flexibility of implementing systems to provide more flexible operational control across provider devices and requester devices. Indeed, conventional systems are also unable to accommodate contextual features for particular transportation requests in selecting pickup and dropoff locations for autonomous vehicles.

Furthermore, conventional systems also suffer from a number of computational inefficiencies. For example, conventional systems that match provider devices with requester devices that are unable to efficiently access nearby pickup or dropoff locations requires significant and inefficient communications between devices over computer networks. To illustrate, as discussed above, conventional systems have difficulty accurately identifying autonomous vehicle accessible locations and device orientation within crowded or busy areas. Accordingly, conventional systems that seek to provide pickup or dropoff locations often generate locations that require significant re-routing instructions and engender duplicative requests from provider devices and requester devices. Moreover, at least in part due to these difficulties, conventional systems often experience increased cancellation requests, which results in duplicative server matching processes, duplicative instructions to client devices, and duplicative notifications to both provider devices and requester devices. Accordingly, conventional systems suffer from inefficient utilization of computing resources (e.g., memory and processing power), excessive bandwidth utilization, and increased latency.

These, along with additional problems and issues, exist with conventional transportation network systems.

### SUMMARY

This disclosure describes one or more embodiments of methods, non-transitory computer-readable media, and systems that utilize computing models to intelligently analyze signals from requester devices and provider devices, determine accurate transition times, and utilize the transition times to select more accurate transition locations for autonomous vehicles and other provider devices. In particular, in one or more embodiments the disclosed systems utilize geohash mapping in conjunction with provider device telematic data to determine transition times across various geographic regions. The disclosed systems can utilize computer models to analyze these transition times and contextual characteristics to select accurate and efficient transition locations for autonomous vehicles. For example, in some implementations, the disclosed systems identify locations that satisfy transition time thresholds and utilize this signal to identify more accurate and efficient autonomous vehicle transition locations. In some implementations, the disclosed systems further improve accuracy for autonomous vehicles by implementing an autonomous vehicle accessible location filter that aligns selected transition locations to areas accessible to autonomous vehicles. The disclosed systems can also utilize other contextual information such as time, transportation mode, provider device rating, number/volume of data points, and/or number of routes to more accurately select transition locations for autonomous vehicles. In this manner, the disclosed systems can improve accuracy, flexibility, and efficiency in determining transition locations and aligning provider devices and requester devices across various geographic regions.

### BRIEF DESCRIPTION OF THE DRAWINGS

The detailed description refers to the drawings briefly described below.

FIG. 1 illustrates a block diagram of an environment for implementing an AV transition location system in accordance with one or more embodiments.

FIG. 2 illustrates selecting a subset of preferred pickup locations based on transition times in accordance with one or more embodiments.

FIG. 3 illustrates monitoring updates from requester and/or provider devices to determine a transition classification for a location in accordance with one or more embodiments.

FIG. 4 illustrates determining transition classifications for a plurality of locations and providing a subset of preferred pickup locations to a vehicle navigation system in accordance with one or more embodiments.

FIG. 5 illustrates utilizing a selection model to analyze transition times and select a subset of preferred pickup locations in accordance with one or more embodiments.

FIG. 6 illustrates providing an example set of preferred pickup locations including transition time metrics to a vehicle navigation system in accordance with one or more embodiments.

FIG. 7 illustrates an autonomous vehicle utilizing a preferred pickup location within a geographic region comprising a plurality of potential pickup options in accordance with one or more embodiments.

FIG. 8 illustrates an example series of acts for determining preferred pickup locations in accordance with one or more embodiments.

FIG. 9 illustrates a block diagram of a computing device for implementing one or more embodiments of the present disclosure.

FIG. 10 illustrates an example environment for a transportation matching system in accordance with one or more embodiments.

### DETAILED DESCRIPTION

This disclosure describes one or more embodiments of an AV transition location system that utilizes computing models to analyze updates from provider devices and requester devices, determine transition times for a variety of locations within various geographic areas, and intelligently select transition locations for autonomous vehicles or other provider devices based on the transition times. In one or more embodiments the AV transition location system analyzes updates from requester devices and/or provider devices at various locations to determine transition times (e.g., an amount of time a provider device is at a particular location). The AV transition location system can aggregate these transition times to establish a measure of threshold-length transition pickups in given geographic areas. Moreover, the AV transition location system can compare the measure of threshold-length transition pickups across locations to select preferred pickup locations for autonomous vehicles operating within the geographic areas. Indeed, depending on a variety of characteristics, the AV transition location system can determine and provide a subset of preferred pickup locations to a vehicle navigation system for navigating provider devices. In this manner, the AV transition location system can improve accuracy, flexibility, and efficiency in generating preferred pickup locations across geographic locations for autonomous vehicles.

To illustrate, in one or more embodiments the AV transition location system utilizes geohash mapping to identify a plurality of pickup locations. Furthermore, the AV transition location system receives updates from provider and requester devices that include telematic data and/or global positioning data to determine transition times at the plurality of pickup locations. To illustrate, the AV transition location system determines an arrival time, monitors updates from requester and/or provider devices, and determines a departure time for a transportation request to determine a transition time for the transportation request. For example, the AV transition location system can monitor provider device location data to determine the length of time a provider remains in the vicinity of the pickup location.

In addition, the AV transition location system can analyze a transition time a location for a transportation request to determine a transition classification. For example, the AV transition location system can compare the transition time for a transportation request with a threshold transition time to determine a transition classification (e.g., a long pickup/dropoff or a short pickup/dropoff).

As mentioned above, the AV transition location system can aggregate transition classifications for a variety of transportation requests. For example, the AV transition location system can combine transition classifications for a plurality of transportation requests at a particular location to determine a measure of threshold-length transition pickups at the location. The AV transition location system can perform a similar analysis for transportation requests across multiple locations. Thus, the AV transition location system can determine a measure of threshold-length transition pickups across different locations based on the transitions at each location.

As mentioned, in one or more embodiments, the AV transition location system determines a subset of preferred pickup locations (or preferred transition locations) to provide to a vehicle navigation system. As an example, the AV transition location system compares a measure of threshold-length transition pickups at a particular pickup location with additional measures of threshold-length transition pickups corresponding to additional pickup locations. Based on this comparison, the AV transition location system selects a subset of preferred pickup locations (e.g., the transition locations with the highest measure of threshold-length transition pickups).

In one or more embodiments, the AV transition location system can utilize a variety of methods to select the subset of preferred pickup locations appropriate for autonomous vehicles. To illustrate, the AV transition location system can utilize an autonomous vehicle location filter to select a filtered subset of areas accessible to autonomous vehicles. Moreover, in some implementations, the AV transition location system utilizes other contextual signals to select preferred transition locations. For example, the AV transition location system can monitor transition times across particular time periods (e.g., time of day or time of week) and select preferred transition times specific to particular time periods. Similarly, the AV transition location system can monitor provider device rating, , the number of transportation requests at pickup locations, , the number of transportation routes, transportation modes, OMS data, digital images of locations, or vehicle speed in a geographic area to select preferred locations for autonomous vehicles. In some implementations, the AV transition location system utilizes a computer-implemented selection model (e.g., an optimization model or a machine learning model) to analyze these various signals to identify preferred transition locations for autonomous vehicles. Accordingly, the AV transition location system can select preferred transition locations for autonomous vehicles based on specific contextual signals.

As suggested above, the AV transition location system provides several improvements or advantages over conventional systems. For instance, the AV transition location system can improve accuracy and operational performance relative to conventional systems. Indeed, unlike conventional systems that struggle to identify and determine pickup locations in intersections, event venues, or otherwise congested areas, the AV transition location system can utilize transition times and other metrics to identify preferred pickup locations in congested locations. Moreover, in one or more embodiments the AV transition location system utilizes a selection model to determine a subset of preferred pickup locations appropriate for autonomous vehicle provider devices under dynamic conditions. Accordingly, the AV transition location system can provide accurate preferred pickup locations that consider unique contextual features at different times or in different circumstances for autonomous vehicles.

The AV transition location system also improves flexibility relative to conventional systems. In particular, rather than relying on the same pickup location selection approach regardless of context or provider device, the AV transition location system generates a subset of preferred pickup locations that accounts for the unique needs of autonomous vehicles and for contextual features. The AV transition location system can also account for difficulties in determining pickup locations in congested geographic areas to provide preferred pickup locations that are more efficient and more accessible to both provider devices and requester devices. Indeed, the AV transition location system generates a subset of preferred pickup locations that can better accommodate autonomous vehicle provider devices or other devices with specialized requirements.

In addition, the AV transition location system improves computing efficiency relative to conventional systems. For example, by utilizing a selection model to provide a subset of preferred pickup locations, the AV transition location system provides pickup locations that require fewer re-routing instructions for autonomous vehicles and reduced requests from provider devices and requester devices. Indeed, because the AV transition location system can provide pickup locations based on transition times and other transportation/rideshare metrics, the AV transition location system results in significantly reduced cancellation requests, routing directions, duplicative matching processes, or duplicative notifications. Thus, the AV transition location system can reduce utilization of computing resources (e.g., processing power and/or memory) and improve network bandwidth.

As indicated by the foregoing discussion, the present disclosure utilizes a variety of terms to describe features and advantages of the AV transition location system. For example, as used herein, the term “provider device” refers to a computing device associated with a transportation provider or driver (e.g., a human driver or an autonomous computer system driver) that operates a transportation vehicle. For instance, a provider device refers to a mobile device such as a smartphone or tablet operated by a provider—or a device associated with an autonomous vehicle that drives along transportation routes. As used herein, an autonomous vehicle (or autonomous vehicle provider device) refers to a vehicle that operates autonomously (e.g., without a human driver). Thus, an autonomous vehicle provider device refers to a self-driving vehicle utilized to respond to transportation requests from requester devices and provide transportation services.

As suggested above, the term “requester device” refers to a computing device associated with a requester that submits a transportation request to a transportation matching system (e.g., a rideshare system). For instance, a requester device receives interaction from a requester in the form of user interaction to submit a transportation request. After the transportation matching system matches a requester (or a requester device) with a provider (or a provider device), the requester can await pickup by the provider at a predetermined pickup location. Upon pickup, the provider transports the requester to a drop-off location specified in the requester's transportation request. Accordingly, a requester may refer to (i) a person who requests a request or other form of transportation but who is still waiting for pickup or (ii) a person whom a transportation vehicle has picked up and who is currently riding within the transportation vehicle to a drop-off location.

As used herein, the term “transportation request” refers to a request from a requesting device (i.e., a requester device) for transport by a transportation vehicle (e.g., a rideshare vehicle). In particular, a transportation request includes a request for a transportation vehicle to transport a requester or a group of individuals from one geographic area to another geographic area. A transportation request can include information such as a requested pickup location, a destination location (e.g., a location to which the requester wishes to travel), a request location (e.g., a location from which the transportation request is initiated), location profile information, a requester rating, or a travel history. As an example of such information, a transportation request may include an address as a destination location and the requester's current location as a requested pickup location. A transportation request can also include a requester device initiating a session via a transportation matching application and transmitting a current location (thus, indicating a desire to receive transportation services from the current location).

Moreover, as used herein, the term “pickup location” refers to a location that a provider device can pick up a requester device. For example, a pickup location can include a designated curb, side of the street, or parking area. To illustrate, pickup locations are often located in an area that is appropriate to park a vehicle separate from oncoming traffic (e.g., a rideshare pickup location for picking up a requester/requester device). Moreover, as used herein, the term “transition location” refers to a stopping location for a transportation vehicle (e.g., a rideshare transition location). For example, a transition location can include a pickup location or a dropoff location for a transportation request.

In addition, as used herein, the term “autonomous vehicle location filter” refers to a computer-implemented algorithm for selecting a transition location for an autonomous vehicle. An autonomous vehicle destination filter can include a computer-implemented algorithm for filtering transition locations incompatible with autonomous vehicles.

Furthermore, as used herein, the term “transition classification” is a category or class for a transition corresponding to a vehicle. As an example, the AV transition location system can determine a transition classification based on a duration of the transition. For example, based on a threshold transition time, a transition that takes longer than the threshold can be classified as a “long transition.” Transitions that take less than the threshold can be classified as a “short transitions.”

As used herein, the term “transition time” refers to an amount of time a vehicle spends (e.g., is stopped) at a transition location. Thus, for example, a transition time (e.g., pickup transition time) includes a time that a transportation vehicle is at a pickup location (e.g., to pick up a requester device) or a dropoff location (e.g., to drop off a requester device). In particular, the transition time (e.g., a rideshare transition time) includes the time after a provider device arrives at a pickup location until the provider device successfully performs a pickup of the requester device and begins the ride to the destination location. To illustrate, the transition time includes the time starting from the arrival of the requester device, the time for coordination at the pickup location between the requester device and provider device, and the time until the provider device leaves the pickup location. Similarly, transition time can include a time that a transportation vehicle remains at a dropoff location.

Moreover, as used herein, the term “pickup transition time” (e.g., a rideshare pickup transition time) refers to an amount of time (e.g., the transition time) a transportation vehicle spends (e.g., is stopped) at a transition location to pickup a requester device. Similarly, the term “dropoff transition time” refers to an amount of time (e.g., the transition time) a transportation vehicle spends (e.g., is stopped) at a transition location to dropoff a requester device.

In addition, as used herein, the term “measure of threshold-length transition pickups” refers to a metric that assesses the number of transition pickups that meet a certain standard or requirement. For example, to calculate this measure, the system can determine the number of transition pickups that satisfy a transition threshold time. In one or more embodiments, the system divides the number of transition pickups that meet the transition threshold time by the total number of transition pickups (e.g., to determine a percentage of long or short pickup classifications).

Further, as used herein, the term “transportation mode” refers to a mode of operation of a provider device (or transportation request corresponding to a provider device). Some examples of transportation modes for a transportation vehicle include: single-passenger mode(in which the provider device is used to transport a single passenger at a time); multi-passenger or shared ride mode (in which the provider device is used to transport multiple passengers traveling along a similar route); luxury mode (in which the vehicle is limited to transportation requests above a threshold value such as high value requests); destination mode (in which the provider device is limited to transportation requests that progress the provider device toward a particular destination selected by the provider device); or delivery mode (in which the provider device is limited to transportation requests for transporting goods or packages from one location to another).

Similarly, as used herein, the term “limited eligibility transportation mode” refers to a transportation mode that limits transportation requests based on specific eligibility criteria. For example, luxury mode or destination mode limit the eligibility of a provider device to a particular subset of transportation requests (e.g., transportation requests above a threshold value or transportation requests that progress toward a provider-selected destination).

In addition, as used herein, the term “provider device rating” (e.g., rideshare provider ratings) is a rating or score for a device provider. Provider device ratings can include a combination of scores or ratings from provider devices that have used the provider devices. The ratings may be based on factors such as reliability of pickups and drop-offs, timeliness in coordinating pickups and dropoffs, and/or the level of satisfaction indicated by requester devices.

Moreover, as used herein, the term “selection model” refers to a computer-implemented model for selecting a subset of preferred pickup locations. In particular, a selection model can include a computer-implemented model for selecting a number of preferred pickup locations based on transition times and other transportation or rideshare metrics (e.g., threshold transition time, AV location filter, transportation mode, provider device rating, number of requests, number of routes).

In one or more embodiments, a selection model includes a machine learning model. As used herein, the term “machine learning model” refers to a computer algorithm or a collection of computer algorithms that can be trained and/or tuned based on inputs to approximate unknown functions. As another example, a machine learning model can include a computer algorithm with branches, weights, or parameters that change based on training data to improve for a particular task. Thus, a machine learning model can utilize one or more learning techniques to improve in accuracy and/or effectiveness. Example machine learning models include various types of decision trees, support vector machines, Bayesian networks, random forest models, or neural networks (e.g., deep neural networks). For instance, the AV transition location system can utilize a convolutional neural network or a recurrent neural network to select preferred transition locations for autonomous vehicles . . . . In one or more embodiments, a selection model includes an optimization model. As used herein, the term “optimization model” refers to a computer algorithm or collection of computer algorithms that balance factors to achieve a particular object or result (e.g., an optimum result). In one or more embodiments, a selection model includes a heuristic model. As used herein, the term “heuristic model” refers to a model that utilizes a set of rules or heuristics to select a preferred pickup location. For example, a heuristic model can utilize a transition time threshold to select preferred pickup locations.

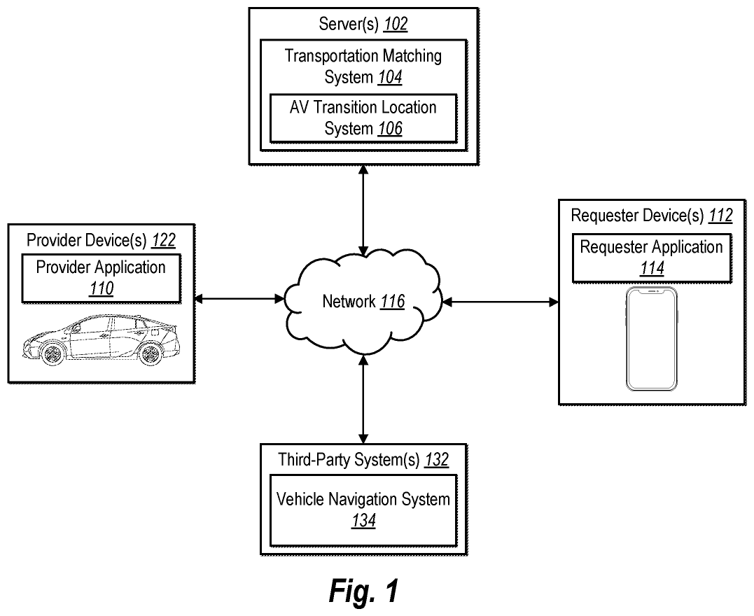

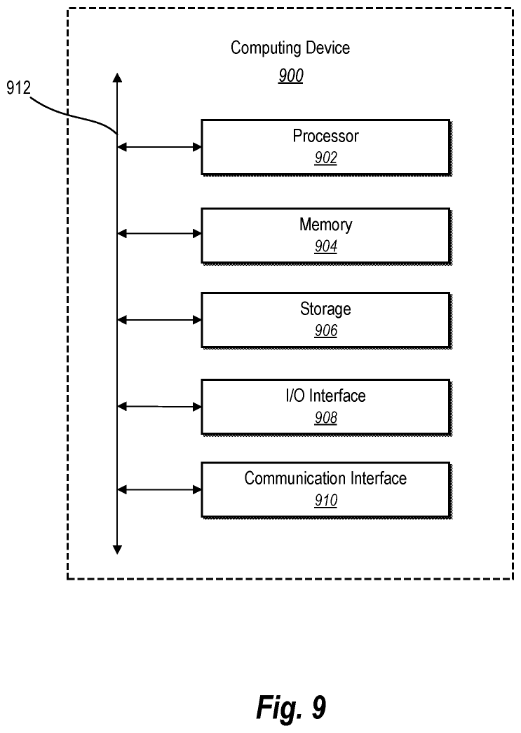

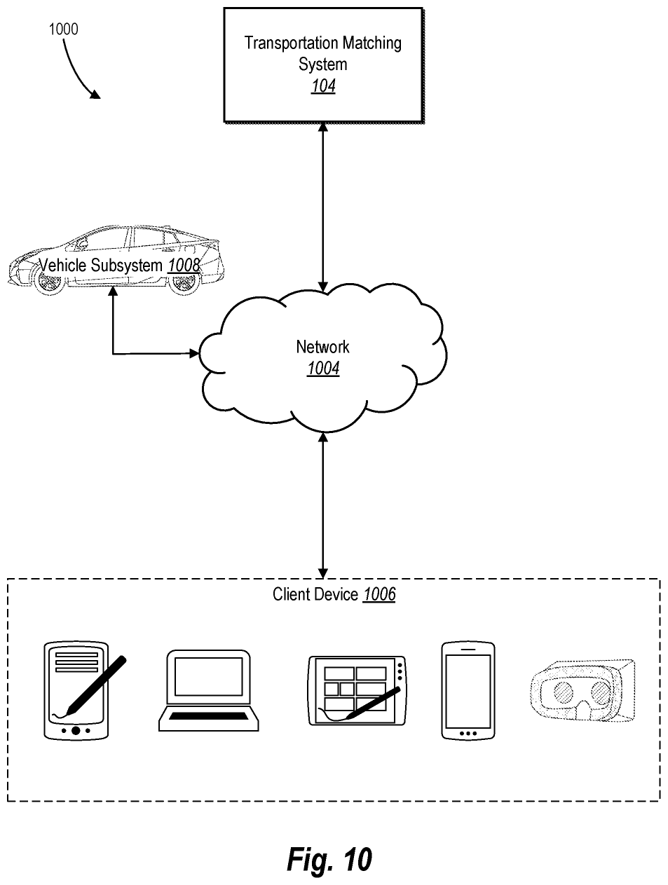

Additional detail regarding the AV transition location system will now be provided with reference to the figures. In particular, FIG. 1 illustrates a block diagram of a system environment for implementing an AV transition location system 106 in accordance with one or more embodiments. As shown in FIG. 1, the environment includes server(s) 102 housing the AV transition location system 106 as part of a transportation matching system 104. The environment of FIG. 1 further includes a provider device(s) 122, and a requester device(s) 112, as well as a network 116. The server(s) 102 can include one or more computing devices to implement the AV transition location system 106. Additional detail regarding the illustrated computing devices (e.g., the server(s) 102, the provider device(s) 122, and/or the requester device(s) 112) is provided with respect to FIGS. 9-10 below.

As shown, the AV transition location system 106 utilizes the network 116 to communicate with the provider device(s) 122 (and other provider devices) and the requester device(s) 112 (and other requester devices). The network 116 may comprise any network described in relation to FIGS. 9-10. For example, the AV transition location system 106 communicates with the provider device(s) 122 (and other provider devices) and the requester device(s) 112 to match transportation requests received from the requester device(s) 112 with the provider device(s) 122 (or another provider device). Indeed, the transportation matching system 104 or the AV transition location system 106 can receive a transportation request from the requester device(s) 112 and can provide request information to various provider device, such as a requested location (e.g., a requested pickup location and/or a requested drop-off location), a requester identification (for a requester corresponding to the requester device(s) 112), and a requested pickup time. In some embodiments, per device settings, the transportation matching system 104 or the AV transition location system 106 receives device information from various provider devices and the requester device(s) 112, such as location coordinates (e.g., latitude, longitude, and/or elevation), orientations or directions, motion information, and indications of user interactions with various interface elements.

As indicated by FIG. 1, the provider device(s) 122 includes the provider application 110. In many embodiments, the transportation matching system 104 or the AV transition location system 106 communicates with the provider device(s) 122 through the provider application 110 to, for example, receive and provide information including location data, motion data, transportation request information (e.g., pickup locations and/or drop-off locations), and transportation route information for navigating to one or more designated locations.

Similarly, the transportation matching system 104 or the AV transition location system 106 communicates with the requester device(s) 112 (e.g., through the requester application 114) to facilitate connecting requests with transportation vehicles. In many embodiments, the AV transition location system 106 communicates with the requester device(s) 112 through the requester application 114 to, for example, receive and provide information including location data, motion data, transportation request information (e.g., requested locations), and navigation information to guide a requester to a designated location.

As indicated above, the transportation matching system 104 or the AV transition location system 106 can provide (and/or cause the provider device(s) 122 to display or render) visual elements within a graphical user interface associated with the provider application 110 and the requester application 114. For example, the transportation matching system 104 or the AV transition location system 106 can provide a digital map for display on the provider device(s) 122 that illustrates a transportation route to navigate to a designated location. The AV transition location system 106 can also provide a transportation request notification for display on the provider device(s) 122 indicating a transportation request. In addition, the AV transition location system 106 can provide a digital map for display on the requester device(s) 112, where the digital map illustrates transportation routes.

The AV transition location system 106 can also provide preferred pickup locations to third-party system(s) 132. To facilitate connecting requests with transportation vehicles, in some embodiments, the transportation matching system 104 or the AV transition location system 106 communicates with the third-party system(s) 132. As indicated by FIG. 1, the third-party system(s) 132 includes the vehicle navigation system 134. In many embodiments, the transportation matching system 104 or the AV transition location system 106 communicates with the third-party system(s) 132 through the vehicle navigation system 134 to, for example, receive and provide information including location data, motion data, transportation request information (e.g., pickup locations and/or drop-off locations), and preferred pickup locations.

Although FIG. 1 depicts the vehicle navigation system 134 located on the third-party system(s) 132, in some implementations, the vehicle navigation system 134 may be implemented by (e.g., located entirely or in part) on one or more components of the environment. For example, the vehicle navigation system 134 may be implemented by the server(s) 102. For example, the provider device(s) 122 can download all or part of the vehicle navigation system 134 for implementation independent of, or together with, the server(s) 102. Similarly, although FIG. 1 depicts the AV transition location system 106 implemented on the server(s) 102, the AV transition location system 106 can be implemented in various components of the environment.

Although FIG. 1 illustrates the environment having a particular number and arrangement of components associated with the AV transition location system 106, in some embodiments, the environment may include more or fewer components with varying configurations. For example, in some embodiments, the transportation matching system 104 or the AV transition location system 106 can communicate directly with the provider device(s) 122 and/or the requester device(s) 112, bypassing the network 116. In these or other embodiments, the transportation matching system 104 or the AV transition location system 106 can be housed (entirely on in part) on the provider device(s) 122 and/or the requester device(s) 112. Additionally, the transportation matching system 104 or the AV transition location system 106 can include or communicate with a database for storing information, such as various machine learning models, historical data (e.g., historical provider device and/or requester device patterns), transportation requests, and/or other information described herein.

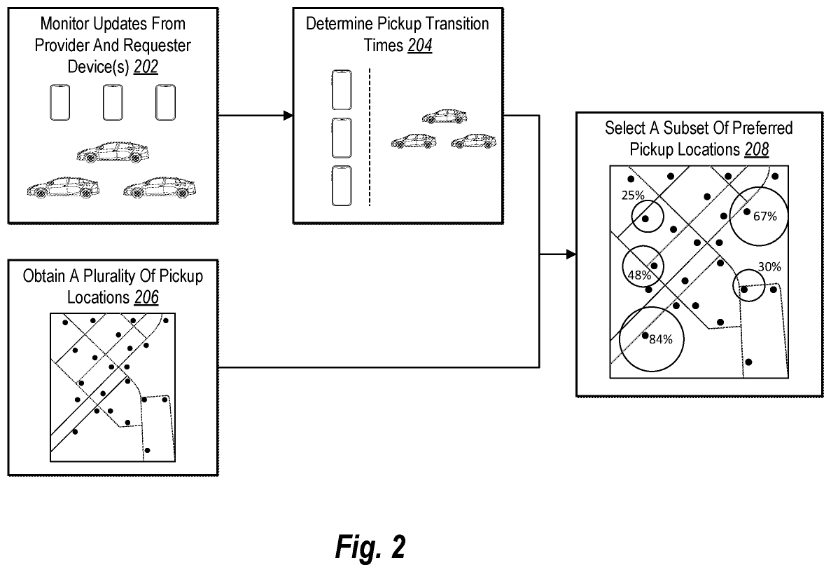

As mentioned, in certain embodiments, the AV transition location system 106 selects a subset of preferred pickup locations for provider devices based on transition times. For example, FIG. 2 illustrates selecting a subset of preferred pickup locations (or dropoff locations) in accordance with one or more embodiments.

Specifically, FIG. 2 illustrates the AV transition location system 106 performing an act 202 of monitoring updates from provider and requester devices. For example, the AV transition location system 106 can monitor updates that include transmission of transportation requests, cancellations, or acceptances. Similarly, the AV transition location system 106 monitors provider devices and requester devices telematic data (e.g., location, speed, idling time, acceleration, fuel consumption) and/or utilizes global positioning data to identify provider devices at various locations utilizing global positioning data and motion data. For example, the AV transition location system 106 performs the act 202 by monitoring telematic data and/or global positioning data from provider devices during transportation requests, pickups, and travel. To illustrate, the AV transition location system 106 identifies telematic data and/or global positioning data indicating a provider device traveling in a direction toward a pickup location. Moreover, the AV transition location system 106 utilizes telematic data and/or global positioning data to determine that the provider device has stopped based on these signals.

Similarly, in one or more embodiments, the AV transition location system 106 monitors provider devices and requester devices in specific geographic locations that include areas accessible to specific vehicle types (e.g., autonomous vehicles or large vehicles) or areas accessible to specific transportation or rideshare modes (e.g., priority service or multiple passengers). Indeed, in one or more embodiments the AV transition location system 106 focuses on more accurate telematic data and/or global positioning data outside of particularly crowded regions or areas.

As further shown in FIG. 2, the AV transition location system 106 performs the act 204 by determining pickup transition times for provider devices by evaluating characteristics of provider device pickups. For example, the AV transition location system determines an arrival time, monitors provider devices and/or requester devices, and a determines a departure time for a transportation request to determine a pickup transition time for the transportation request. Indeed, the AV transition location system can monitor provider device and/or requester device location data (as described above) to determine the length of time a provider remains in a vicinity of the pickup location to determine a transition time. For example, the AV transition location system 106 determines a time metric that represents the average transition time for a plurality of pickup locations (e.g., a time metric of 99 seconds or 159 seconds). Similarly, the AV transition location system 106 determines a time metric that represents the measure of pickups that satisfy a threshold transition time for a plurality of pickup locations (e.g., a time metric of 25% or 48%). The time metric can account for driving conditions, transportation mode (e.g., multi-passenger mode or limited eligibility transportation mode), weather conditions, traffic, accidents, time of day, events or other incidents that impacted pickup transition times.

Moreover, as illustrated, the AV transition location system 106 performs the act 206 of obtaining a plurality of pickup locations in a geographic area. The pickup locations may be associated with a particular location identifier (e.g., a geohash) in a geographical location serviced by the AV transition location system. A geohash may include a unique identifier of a specific region on the Earth; for example, using a geocoding system that comprises hierarchical spatial data structures that can operate to subdivide space into shapes. A geohash may be of varying sizes or resolutions; for example, geohash-5 versus geohash-6 can describe geohashes of different size. A geohash can be a convenient way of expressing a location (anywhere in the world) using, for example, a short alphanumeric string, such as short URLs which uniquely identify positions on the Earth.

For example, the AV transition location system 106 compares telematic data and/or global positioning data with known coordinates of pickup locations to obtain a plurality of pickup locations. Specifically, in one or more embodiments, the AV transition location system 106 utilizes transportation data to obtain an indicator of possible pickup locations that are available for pickups within a geographic area. For example, the AV transition location system 106 can evaluate transportation data from previous pickups to obtain an indicator of pickup locations that have been successfully used by other provider devices. In one or more embodiments, the AV transition location system 106 can utilize a third-party listing of pickup locations that satisfy the transportation criteria. For example, the AV transition location system 106 can utilize third-party applications to integrate navigational data and mapping to obtain a listing of pickup locations in the geographic area. As illustrated in FIG. 2, the AV transition location system 106 also performs an act 208 of selecting a subset of preferred pickup locations. As illustrated in FIG. 2, in one or more embodiments, the AV transition location system 106 selects a subset of preferred pickup locations based on pickup transition times at pickup locations within the geographic area. For example, the AV transition location system 106 can select the subset of preferred pickup locations from a plurality of pickup locations based on the measure of pickups that satisfy a transition time threshold. As shown on FIG. 2, the AV transition location system 106 can select the subset of preferred pickup locations as locations where the measure of pickups that satisfy a transition time threshold of 25%. Alternatively in one or more embodiments, although not shown, the AV transition location system 106 can select the subset of preferred pickup locations that have average pickup transition times over a threshold amount (e.g., 99 seconds).

Although FIG. 2 (and other figures herein) illustrate selecting a subset of preferred pickup locations, the AV transition location system 106 can also perform the acts described herein with regard to dropoff locations and/or pickup locations. Thus, for example, the AV transition location system 106 can monitor provider and requester devices at pickup and/or dropoff locations, determine dropoff transition times, and select a subset of preferred pickup and/or dropoff locations. Similarly, the AV transition location system 106 can select the subset of preferred dropoff locations from a plurality of dropoff locations based on the measure of pickups that satisfy a transition time threshold.

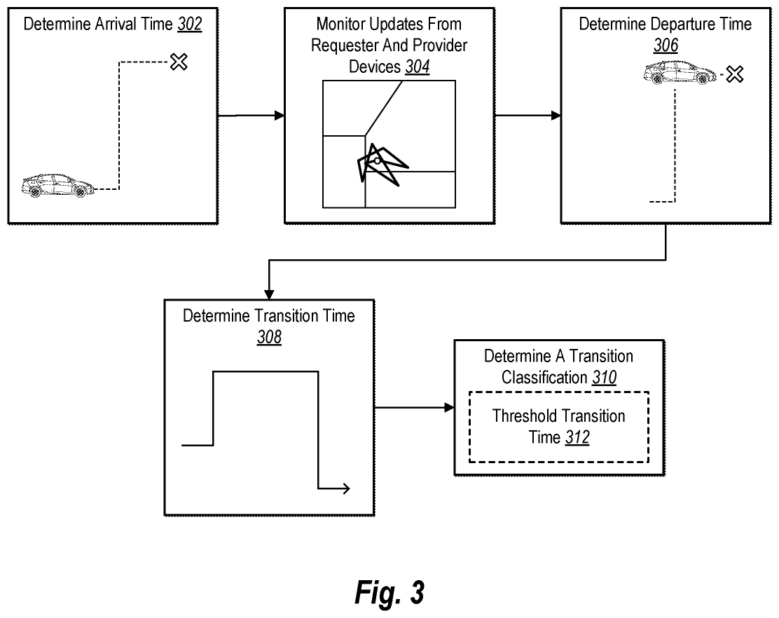

As mentioned above, the AV transition location system 106 can determine a transition classification for pickup transition times associated with pickup locations. In particular, FIG. 3 illustrates determining a transition classification associated with a pickup transition time according to one or more embodiments.

As illustrated in FIG. 3, the AV transition location system 106 performs the act 302 of determining an arrival time for a provider device at a pickup location. As mentioned, the AV transition location system 106 can utilize telematic data and/or global positioning data from provider devices during requests to establish the arrival time of the provider device at the pickup location. In one or more embodiments, the provider device provides the AV transition location system 106 with a notification when the provider device arrives at the pickup location. In one or more embodiments, the arrival time can include time the provider device spends waiting for access to the pickup location within a threshold distance from the pickup location.

As further illustrated in FIG. 3, the AV transition location system 106 performs the act 304 by monitoring updates from the requester device and the provider device. As shown, the AV transition location system 106 monitors the telematic data and/or global positioning data from the provider device and/or requester device to determine if the device is located in the vicinity of the pickup location. Indeed, the AV transition location system 106 compares the location of the requester device with the location of the provider device to determine when the requester device and the provider device have converged at the pickup location. Additionally, the AV transition location system 106 monitors the telematic data and/or global positioning data from the provider device to determine when a provider device remains in the vicinity of the pickup location.

As further illustrated in FIG. 3, the AV transition location system 106 performs the act 306 to determine the departure time of the provider device and/or the requester device from the pickup location. In particular, the AV transition location system 106 monitors the telematic data and/or global positioning data from the provider device and/or requester device to determine when the device moves from the pickup location. In one or more embodiments, the provider device and/or the requester device provides the AV transition location system 106 with a notification when the provider device departs from the pickup location.

As shown in FIG. 3, the AV transition location system 106 performs an act 308 of determining a transition time (e.g., pickup transition time or dropoff transition time) at the pickup location. Utilizing the information gleaned from the acts 302, 304, and 306, the AV transition location system 106 performs the act 308 to determine the transition time. As mentioned, the transition time can include the amount of time the provider device is located at the pickup or dropoff location measured from the arrival time to the departure time.

As shown in FIG. 3, the AV transition location system 106 determines a transition classification for the transition time. In particular, the AV transition location system 106 performs the act 310 of determining a transition classification. The AV transition location system 106 determines a transition classification based on analyzing the transition time and comparing the transition time with one or more thresholds. For example, the AV transition location system 106 can compare a pickup transition time (or dropoff transition time) at to a threshold transition time 312 to determine a transition classification (e.g., a long transition classification above the threshold or a short transition classification below the threshold).

The AV transition location system 106 can determine threshold transition time 312 based on a variety of factors. For example, the AV transition location system 106 can analyze historical data of known pickup locations (e.g., known AV pickup locations) to determine the threshold transition time 312. To illustrate, the AV transition location system 106 can determine a historical transition time for one or more of the known pickup locations and utilize the historical transition time to determine the threshold transition time 312. In some embodiments, the AV transition location system 106 combines historical transition times across various known AV pickup locations (e.g., averages or takes an average with a determined deviation) to determine the threshold transition time 312.

The AV transition location system 106 can utilize dynamic thresholds that change based on different contextual characteristics. For example, in some implementations, the AV transition location system 106 utilizes a first threshold for a first time of day and a second threshold for a second time of day. Similarly, the AV transition location system 106 can select and utilize different thresholds based on different transportation modes, provider device ratings, or other transition metrics.

The AV transition location system 106 can also utilize different numbers of thresholds. For example, the AV transition location system 106 can utilize two, three, or four thresholds to determine different transition classifications (e.g., long, medium, and short pickup transition classes).

Thus, in one or more embodiments, the AV transition location system 106 determines transition classifications based on various contextual features that impact transition times. For example, the AV transition location system 106 can determine a transportation mode corresponding to the transportation request and determine the transition classification specific to that transportation mode (e.g., long pickup for a multi-passenger mode or a short pickup for a multi-passenger mode). Similarly, the AV transition location system 106 can determine transportation classifications specific to time of day, for specific events, or other contextual features.

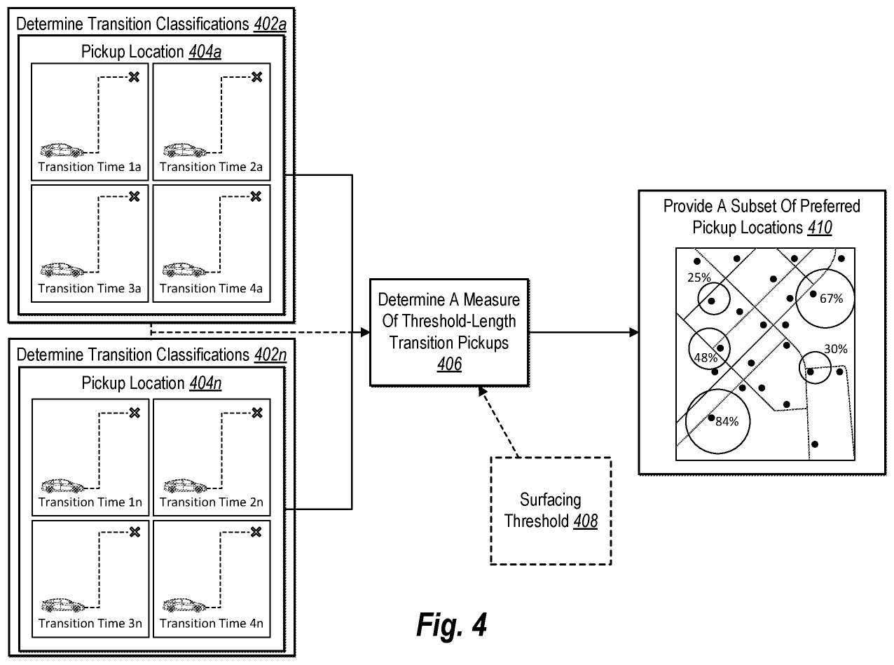

The AV transition location system 106 can also utilize transition classifications to select and provide a subset of preferred pickup or dropoff locations to a vehicle navigation system. For example, FIG. 4 illustrates providing a subset of preferred pickup locations based on a measure of threshold-length transition pickups in accordance with one or more embodiments.

Specifically, FIG. 4 illustrates the AV transition location system 106 performing acts 402a-402n of determining transition classifications for a plurality of pickup locations 404a-404n. As described above with regard to FIG. 3, the AV transition location system 106 determines transition times 1a, 2a, 3a, and 4a that correspond to a pickup location 404a. Moreover, by combining the transition times 1a, 2a, 3a, and 4a the AV transition location system 106 can determine an expected pickup transition time at the pickup location 404a.

As discussed above, the AV transition location system 106 can also determine a transition classification for a pickup that corresponds to a transition time for that pickup location. For instance, as shown on FIG. 4, the AV transition location system 106 determines a plurality of transition times for transportation requests corresponding to a pickup location (e.g., pickup locations 404a-404n) and determines transition classifications for the plurality of transition times. To illustrate, the AV transition location system 106 can compare the transition times 1a, 2a, 3a, and 4a corresponding to the pickup location 404a with threshold transition times to determine transition classifications 402a for the pickup location 404a. Similarly, the AV transition location system 106 can compare transition times 1n, 2n, 3n, and 4n with threshold transition times corresponding to a pickup location 404n to determine transition classifications 402n for the pickup location 404n.

As further shown on FIG. 4, the AV transition location system 106 performs an act 406 to determine a measure of threshold-length transition pickups for the plurality of pickup locations 404a-404n. Specifically, the AV transition location system 106 can determine a measure of instances when the transition classifications 402a-402n satisfies a transition classification requirement of the AV transition location system 106. In one or more embodiments, the measure of threshold-length transition pickups can be a percentage value of a certain transition classification (e.g., a percentage of long pickups classifications or a percentage of short pickups classifications). To illustrate, in one or more embodiments, the AV transition location system 106 can determine the measure of threshold-length transition pickups for pickup location 404a by determining a measure of how often transition times at the pickup location 404a are long pickups.

In one or more embodiments, the AV transition location system 106 performs an act 408 to compare the measure of threshold-length transition pickups to a surfacing threshold. For example, the AV transition location system 106 can determine a first measure of threshold-length transition pickups for a first location (e.g., 75%) and compare the first measure of threshold-length transition pickups to the surfacing threshold (e.g., 50%). If the first measure of threshold-length transition pickups satisfies the surfacing threshold, the AV transition location system 106 selects the transition location to include in a subset of preferred pickup locations. Similarly, the AV transition location system 106 can determine a second measure of threshold-length transition pickups for a second location (e.g., 35%) and compare the second measure of threshold-length transition pickups to the surfacing threshold (e.g., 50%). If the second measure of threshold-length transition pickups does not satisfy the surfacing threshold, the AV transition location system 106 does not select the transition location for inclusion in the subset of preferred pickup locations.

The AV transition location system 106 can utilize a variety of different approaches to select a subset of preferred pickup locations. For example, the AV transition location system 106 can directly compare measures of threshold-length transition pickups across locations and select a subset of locations based on the comparison. To illustrate, the AV transition location system 106 can select the top number (e.g., top 10) or top percentage (e.g., top 10%) of locations with the highest measure of threshold-length transition pickups.

Although FIG. 4 illustrates utilizing a measure of threshold-length transition pickups, the AV transition location system 106 can utilize a variety of other approaches to select a subset of preferred pickup locations. For example, the AV transition location system 106 can directly compare transition times for various locations. To illustrate, the AV transition location system 106 can choose the locations (e.g., a number or percentage of locations) with the highest average transition time. Indeed, the AV transition location system 106 can determine and compare a variety of different statistical measures of transition time (e.g., average, mean, median, deviation) and compare the statistical measures to select the subset of preferred pickup locations.

As further shown on FIG. 4, the AV transition location system 106 can perform an act 410 of providing a subset of preferred pickup locations. Specifically, as just discussed above, the AV transition location system 106 can compare the measure of threshold-length transition pickups (or other measure of transition times/transition classifications)across the pickup locations to generate a subset of preferred pickup locations. Thus, for example, the AV transition location system 106 can provide all pickup locations that have at least a 60% long pickup classification rate.

Additionally, the AV transition location system 106 can provide an indication of the measure of the transition time (e.g., measure of threshold-length transition pickups) associated with each pickup location of the subset of preferred pickup locations. In particular, as shown in FIG. 4, the AV transition location system 106 can provide an indication a percentage of threshold-length transition pickups. To illustrate, the AV transition location system 106 can provide an indication of 84% for a location that satisfies the threshold transition time at an 84% rate.

In some embodiments, the AV transition location system 106 provide the subset of preferred pickup locations by providing a complete list of pickup locations while designating the subset of preferred pickup locations. For example, the AV transition location system 106 can provide a list of all pickup locations but provide the subset of preferred pickup locations by designating a measure of transition time and/or the measure of threshold-length transition pickups (thereby identifying those with the highest rate of long pickup classifications and/or the highest transition times).

Moreover, the AV transition location system 106 can also select and provide a subset of preferred pickup locations based on the number of requests. Indeed, as shown in FIG. 4, the size of the circle surrounding the pickup locations indicates the number of observed transitions corresponding to that location. In some embodiments, the AV transition location system 106 selects the subset of preferred pickup locations based on the number of transportation requests (e.g., the higher the number of transportation requests/transitions the greater the confidence). For instance, the AV transition location system 106 can only provide a pickup location if it has a threshold number of transportation requests/transitions. Similarly, the AV transition location system 106 can weight or punish a pickup location based on the number of transitions at the pickup location (e.g., provide a positive weighting for a large number of pickups and a negative weighting for a small number of pickups).

Although FIG. 4 illustrates providing a subset of preferred pickup locations, the AV transition location system 106 can also perform the acts enumerated above with regard to dropoff locations and/or pickup locations. Thus, for example, the AV transition location system 106 can determine transition classifications at pickup and/or dropoff locations, determine a measure of threshold-length transition pickups and/or dropoffs, and provide a subset of preferred pickup and/or dropoff locations. Similarly, the AV transition location system 106 can provide the subset of preferred dropoff locations from a plurality of dropoff locations based on the measure of pickups that satisfy a transition time threshold.

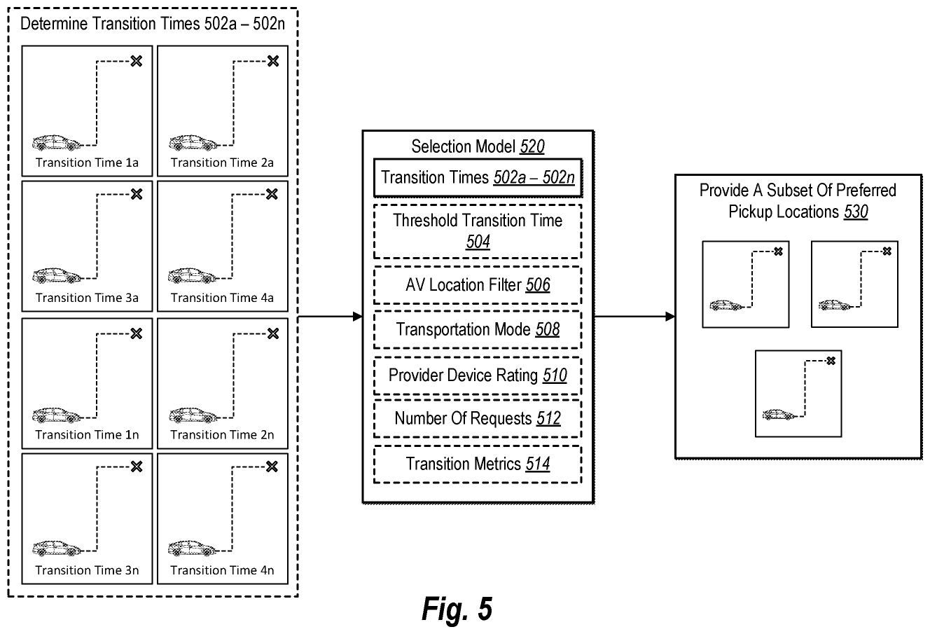

The AV transition location system 106 can provide a subset of preferred pickup locations based on a variety of factors and utilizing a variety of computer-implemented algorithms. For example, FIG. 5 illustrates selecting a subset of preferred pickup locations in accordance with one or more embodiments.

Specifically, FIG. 5 illustrates the AV transition location system 106 utilizing a selection model 520 to select a subset of preferred pickup locations from a plurality of pickup locations. As shown, the AV transition location system 106 determines transition times 502a-502n for the plurality of pickup locations. Thereafter, the AV transition location system 106 utilizes a selection model 520 to determine a subset of preferred pickup locations based on the transition times 502a-502n and other possible factors.

For example, as discussed above, the selection model 520 can utilize a heuristic model by applying a threshold transition time 504 to select a subset of preferred pickup locations. To illustrate, in one or more embodiments, the AV transition location system 106 compares the transition times 502a-502n to a threshold transition time 504 to select a subset of preferred pickup locations with transition times that satisfy a threshold transition time. Indeed, when selecting a subset of preferred pickup locations accessible to AV provider devices, the AV transition location system 106 selects a subset of preferred pickup locations that satisfy a long pickup transition time threshold requirement.

In one or more embodiments, the AV transition location system 106 utilizes an AV location filter 506 to select a subset of preferred pickup locations. To illustrate, in one or more embodiments, the AV transition location system 106 compares locations that satisfy an AV location filter 506 with pickup locations with transition times 502a-502n to select a subset of preferred pickup locations. For instance, the AV transition location system 106 limits the plurality of pickup locations to locations that satisfy an AV location filter 506 and are accessible to AV provider devices. Indeed, the AV transition location system 106 selects a subset of preferred pickup locations based on both the transition times 502a-502n and the AV location filter 506.

In some embodiments, the AV transition location system 106 utilizes a heuristic function (e.g., rule-based function) or an optimization model (e.g., that weights various factors to optimize or improve a particular objective). For example, as illustrated in FIG. 5, the AV transition location system 106 can generate rules or weights for individual pickup locations based on various additional features, such as an AV location filter, a transportation mode, a provider device rating, a number of requests, and other transition metrics or contextual features.

To illustrate, the AV transition location system 106 can utilize an autonomous vehicle location filter to select a filtered subset of areas accessible to autonomous vehicles. To illustrate, the AV transition location system 106 can account for autonomous vehicle mobility restrictions in specific areas and under certain road conditions to filter the plurality of pickup locations to only include locations accessible to autonomous vehicles. As another example, the AV transition location system 106 can filter the preferred pickup locations to exclude areas with traffic rules or patterns prohibitive to operation of an autonomous vehicle. In addition, the AV transition location system 106 can filter preferred pickup locations based on road markings or available traffic lanes. To illustrate, the AV transition location system 106 can provide preferred pickup locations based on areas determined to be appropriate for autonomous vehicle providers to travel.

In one or more embodiments, the AV transition location system 106 evaluates a transportation mode 508 to select a subset of preferred pickup locations. To illustrate, in one or more embodiments, the AV transition location system 106 compares transition times 502a-502n to a transportation mode when weighing the transition times for provider devices. For example, the AV transition location system 106 can account for increase in transition times that often occurs in a multi-passenger transportation mode when compared to a single passenger transportation mode. Thus, for example, the AV transition location system 106 can weight transition times less heavily for multi-passenger transportation modes (i.e., because the multi-passenger transportation modes can skew the results). Similarly, the AV transition location system 106 can weight transition times differently for limited eligibility transportation modes. As another example, the AV transition location system 106 can account for the increase in transition times that often occurs in an AV transportation mode when compared to a manned vehicle transportation mode. Indeed, the AV transition location system 106 can account for various modes having differences in transition times that are partially related to the transportation mode (rather than strictly the pickup location).

In one or more embodiments, the AV transition location system 106 evaluates a provider device rating 510 to select a subset of preferred pickup locations. To illustrate, in one or more embodiments, the AV transition location system 106 compares transition times 502a-502n to a provider device rating 510 when weighing the transition times for provider devices. Indeed, provider device rating can influence the amount of transition time for a particular location (e.g., low driver rating can equate to higher wait times). The AV transition location system 106 can weight transition times based on provider device ratings to account for these differences.

In one or more embodiments, the AV transition location system 106 evaluates a number of requests 512 at a pickup location to select a subset of preferred pickup locations. To illustrate, in one or more embodiments, the AV transition location system 106 compares transition times 502a-502n to a number of requests 512 when weighing the transition times for provider devices. For example, as mentioned above, the AV transition location system 106 can place a heavier weight on locations that have a higher number of transportation requests/transitions. For example, the AV transition location system 106 can determine that a particular location has received a larger number of requests overall and therefore the AV transition location system 106 has a greater confidence in the validity of the transition time determined for that location (due to a larger dataset). For example, for locations with higher transition times (above a transition threshold) and a high volume, the AV transition location system 106 can place a higher reward on selecting the transition location. However, for locations with lower transition times (below a transition threshold) and a high volume, the AV transition location system 106 can place a higher penalty (or smaller reward) on selecting the transition location.

In one or more embodiments, the AV transition location system 106 evaluates other transition metrics 514 to select a subset of preferred pickup locations. To illustrate, in one or more embodiments, the AV transition location system 106 compares transition times 502a-502n to transition metrics 514 when weighing the transition times for provider devices. For example, the AV transition location system 106 can measure and account for transition metrics 514 such as the requester device wait times, requester device walking distance, availability of parking spots on the road, prominence of bike lanes, use of one-way streets, number or probability of cancelled rides, number of requester devices or provider devices for a geographic region, the transportation volume for a geographic region, transportation route or segment utilization, vehicle occupancy, vehicle speed, inclement weather, time of day, planned events, vehicle accidents, or fleet vehicle street level imagery. Indeed, the AV transition location system 106 can evaluate the transition times 502a-502n and the transition metrics 514 to determine if the transition times 502a-502n provide an accurate representation of typical transition times at the associated pickup locations. Based on evaluating the transition times 502a-502n and the transition metrics 514, the AV transition location system 106 can determine a subset of preferred pickup transition times.

The AV transition location system 106 can also utilize the transition metrics 514 as signals to weight in selecting a preferred pickup location. Indeed, the AV transition location system 106 can weight the transition metrics 514 in conjunction with transition times to select a preferred pickup location. Thus, for instance, the AV transition location system 106 can consider transition times together with requester device wait times and requester device walking distance to select preferred pickup locations. The AV transition location system 106 can also analyze street image data, cancelled rides, and street imagery to select a preferred pickup location.

Additionally, the AV transition location system 106 can provide a priority order within the subset of preferred pickup locations within a geographic area. The AV transition location system 106 can determine a priority order for types/categories based on a variety of factors. For example, in some embodiments, the AV transition location system 106 selects the priority order based on the time or distance of the preferred pickup locations from the requester device. In some embodiments, the AV transition location system 106 selects the priority based on historical data (e.g., historical data indicating which pickup location results in the most efficient pickup location). In some embodiments, the AV transition location system 106 selects the priority based on the results from the selection model 520. Specifically, the AV transition location system 106 analyzes the subset of preferred pickup locations, the transition times, and the location of the requester device to suggest a priority order within the subset of preferred pickup locations.

As mentioned, the selection model 520 can utilize an optimization model to balance transition times, the threshold transition time 504, AV location filter 506, transportation mode 508, provider device rating 510, number of requests 512, and the other transition metrics 514. Specifically, the selection model 520 can define a set of decision variables that represent the different pickup locations. Additionally, the optimization model employs a set of constraints that define the limits on the decision variables (e.g., restriction on traffic routes, restriction on a time window). Additionally, the optimization model employs an objective function that defines what to optimize for (e.g., the minimum distance traveled, the lowest transition times). By utilizing an optimization model, the AV transition location system 106 can efficiently provide a subset of preferred pickup transition times utilizing large numbers of decision variables and constraints. Indeed, the AV transition location system 106 can utilize a variety of optimization algorithms including linear, integer and constraint programming.

As mentioned, the selection model 520 can utilize a machine learning model, such as a decision tree or neural network to select preferred pickup locations. To elaborate, the AV transition location system 106 utilizes a preferred pickup prediction machine learning model to determine or predict a subset of preferred pickup locations from the plurality of pickup locations. For example, the AV transition location system 106 can utilize a preferred pickup prediction machine learning model trained on input features and ground truth pickup information to select preferred pickup locations.

To illustrate, the AV transition location system 106 can identify a set of ground truth AV transition locations (e.g., locations that AVs commonly utilize to pickup or dropoff passengers). The AV transition location system 106 can generate or monitor a variety of input signals regarding the ground truth AV transition locations. For instance, the AV transition location system 106 can analyze transition times, modes, provider device ratings, number of requests/transitions, and other transition metrics discussed above (e.g., wait times, walking times, street level imagery, etc.). The AV transition location system 106 can analyze these input signals utilizing a machine learning model (e.g., decision tree or neural network) to generate a transition prediction.

For example, the AV transition location system 106 can generate a classification transition prediction (e.g., a binary classification) indicating that the pickup location is an AV-pickup-location or a non-AV-pickup-location. Similarly, the AV transition location system 106 can generate a non-binary prediction (e.g., a probability or a transition time) indicating a measure of fit for the location for an AV transition. The AV transition location system 106 can then compare the generated prediction to the ground truth.

To illustrate, the AV transition location system 106 can utilize a loss function to compare the transition prediction to the ground truth. Thus, for example, the AV transition location system 106 can compare a binary prediction to the ground truth indication of whether the location was an AV transition location. Similarly, the AV transition location system 106 can compare a non-binary prediction to a ground truth (e.g., a rating of the location or the ground truth transition time for the location). The AV transition location system 106 can utilize a loss function to determine a measure of loss between the ground truth and the prediction. The AV transition location system 106 can then modify parameters of the machine learning model based on the measure of loss. For example, the AV transition location system 106 can utilize gradient descent and/or back propagation to modify parameters of the machine learning model to reduce the measure of loss. The AV transition location system 106 can iteratively train the machine learning model to improve the accuracy of predictions.

At run time, the AV transition location system 106 can analyze features of a particular location utilizing trained parameters of the machine learning model. The AV transition location system 106 can generate a transition prediction indicating the suitability of a particular location for an AV transition. The AV transition location system 106 can utilize the transition prediction to select a subset of preferred pickup locations. For example, the AV transition location system 106 can select those locations that the machine learning model classifies as AV transition locations. Similarly, the AV transition location system 106 can select those locations that satisfy a probability threshold or that exceed a predicted transition time. As further shown on FIG. 5, the AV transition location system 106 can perform an act 530 to provide a subset of preferred pickup locations. Specifically, the AV transition location system 106 can utilize the selection model 520 to generate a subset of preferred pickup locations. To illustrate, the AV transition location system 106 can provide a subset of recommended pickup locations that based on evaluating the transition times 502a-502n and one or more of the other factors shown on FIG. 5.

Although FIG. 5 illustrates providing a subset of preferred pickup locations, the AV transition location system 106 can also perform the acts enumerated above with regard to dropoff locations and/or pickup locations. Thus, for example, the AV transition location system 106 can utilize a selection model with factors such as: transition times, a threshold transition time, an AV location filter, a transportation mode, a provider device rating, a number of requests, and/or transition metrics. Similarly, the AV transition location system 106 can select the subset of preferred dropoff locations from a plurality of dropoff locations based on factors considered by the selection model.

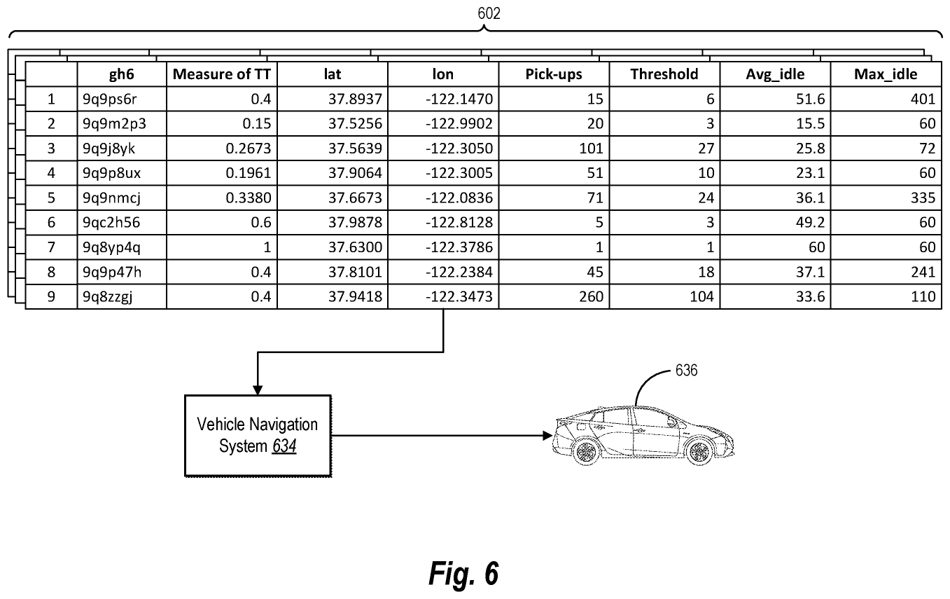

As mentioned, in certain embodiments the AV transition location system 106 communicates with a vehicle navigation system. For example, FIG. 6 illustrates providing transition metrics to a vehicle navigation system 634 (e.g., the vehicle navigation system 134). As mentioned, the vehicle navigation system 634 may be implemented by (e.g., located entirely or in part) the AV transition location system 106. In some embodiments, the vehicle navigation system 634 is a third-party system (e.g., a third-party that controls navigation of the autonomous vehicles).

As illustrated in FIG. 6, the AV transition location system 106 can provide transition metrics 602 to the vehicle navigation system 634. For example, the AV transition location system 106 can provide a measure of the transition time for a pickup location, longitude and latitude, a number of pickups for a preferred pickup location, a number of transition times meeting a threshold, an average idle time at the preferred pickup location, and a maximum idle time at the preferred pickup location.

Indeed, as shown on FIG. 6, the AV transition location system 106 can provide multiple values for the transition metrics 602 to account for changes to the transition metrics 602. In particular, the AV transition location system can determine multiple subsets of preferred pickup locations corresponding to multiple time periods (e.g., time of day, time of week, time of year) and/or locations. For example, the AV transition location system 106 can adjust the subset of preferred pickup locations based on inclement weather, yearly seasons, events, road construction, vehicle accidents, traffic congestion, or a tourist season. Indeed, the AV transition location system can provide multiple subsets of preferred pickup locations to a vehicle navigation system based on these changeable conditions.

As mentioned above, the AV transition location system 106 can generate time-specific values by monitoring time for transportation requests and transitions. Indeed, the AV transition location system 106 can utilize transportation requests between 12:00 and 1:00 to generate transition times and preferred pickup locations specific to that time period. Moreover, the AV transition location system 106 can utilize transportation requests between 5:00 and 6:00 to generate transition times and a different set of preferred pickup locations specific to that time period. The AV transition location system 106 can collect and utilize similar information for repeating events, weather conditions, or other contextual features.

Although FIG. 6 illustrates an example illustrate of values provided to the vehicle navigation system 634, the AV transition location system 106 can provide a variety of different formulations. For example, in some embodiments, the AV transition location system 106 provides a data table that includes one row for every pickup location (e.g., block or OSM segment) and percentages (e.g., measure of threshold-length transition pickups) for those locations (e.g., a geographic point in time plus a percentage).

As further illustrated on FIG. 6, the vehicle navigation system 634 may in turn communicate with provider devices 636 to provide a subset of preferred pickup locations based on the subset of preferred pickup locations and the transition metrics 602.

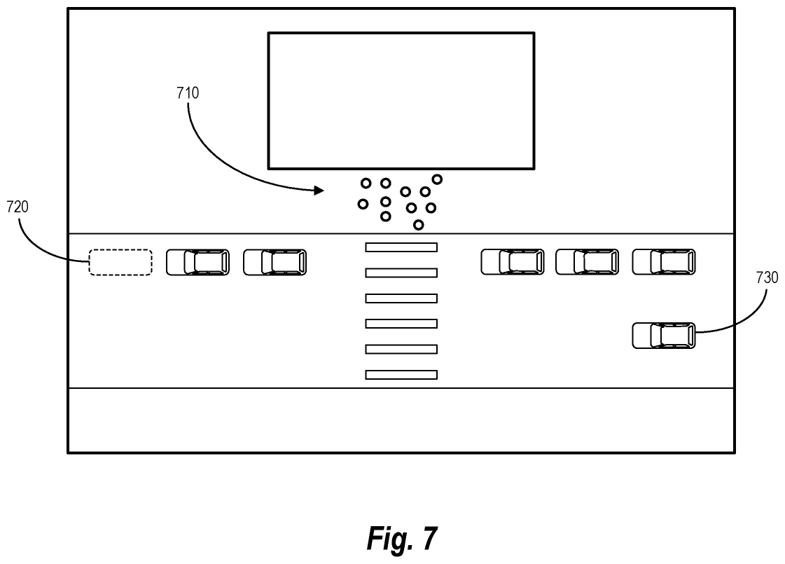

As mentioned, in certain embodiments, the AV transition location system 106 provides a subset of preferred pickup locations for provider devices based on evaluating transition times and additional factors. For example, FIG. 7 illustrates selection of a preferred pickup location at a crowded business location in accordance with one or more embodiments.

Specifically, FIG. 7 illustrates a crowded location with multiple requester devices 710 in a congested area. Choosing an appropriate pickup location in a congested area can be challenging for AV provider devices. In the case of transportation with a human driver, the requester has multiple options to guide the provider to an alternate pickup location. For example, the requester could wave to the driver in a crowded area to get their attention, call out vocally, or use a visual marker (such as a brightly colored item that is easy to see from a distance) to help the driver spot them. However, an AV provider device does not have a human driver, nor the same options, to establish an alternate pickup location. Thus, conventional systems often select poor or incompatible locations and allow provider and requesters coordinate or negotiate a different pickup location.

Autonomous vehicles, however, do not have human drivers that can easily coordinate alternative pickup locations based on verbal or visual cues with a requester device. Accordingly, the AV transition location system 106 identifies transition locations for autonomous vehicles to address this technical deficiency. Indeed, the AV transition location system 106 selects transition locations that allow autonomous vehicles to successfully pickup or dropoff provider devices based on transition times signaling that a particular location is suitable for autonomous vehicles.

Thus, for example, FIG. 7 illustrates a geographic region (e.g., an event center or other crowded location) with multiple potential transition locations. The AV transition location system 106 can analyze the transition locations within the geographic region and select one or more preferred transition locations for autonomous vehicles. To illustrate, the AV transition location system 106 can analyze transition times to select pickup or dropoff locations that are less crowded, more visible, or easier to access for autonomous vehicles and require less personal coordination.

Thus, as shown, the AV transition location system 106 identifies the preferred pickup location 720 for the provider device 730 as discussed above and based on determined transition times at the preferred pickup location 720. Indeed, as shown, the AV transition location system 106 directs the provider device 730 to the preferred pickup location 720 on the side of the road most accessible to the requester device and slightly removed from the crowded business access point.

In one or more embodiments, each of the components of the AV transition location system 106 are in communication with one another using any suitable communication technologies. Additionally, the components of the AV transition location system 106 can be in communication with one or more other devices including one or more client devices described above. Furthermore, although the components of the figures are described in connection with the AV transition location system 106, at least some of the components for performing operations in conjunction with the AV transition location system 106 described herein may be implemented on other devices within the environment.

The components of the AV transition location system 106 can include software, hardware, or both. For example, the components of the AV transition location system 106 can include one or more instructions stored on a computer-readable storage medium and executable by processors of one or more computing devices. When executed by the one or more processors, the computer-executable instructions of the AV transition location system 106 can cause the computing device to perform the methods described herein. Alternatively, the components of the AV transition location system 106 can comprise hardware, such as a special purpose processing device to perform a certain function or group of functions. Additionally or alternatively, the components of the AV transition location system 106 can include a combination of computer-executable instructions and hardware.

Furthermore, the components of the AV transition location system 106 performing the functions described herein may for example, be implemented as part of a stand-alone application, as a module of an application, as a plug-in for applications including content management applications, as a library function or functions that may be called by other applications, and/or as a cloud-computing model. Thus, the components of the AV transition location system 106 may be implemented as part of a stand-alone application on a personal computing device or a mobile device. Alternatively, or additionally, the components of the AV transition location system 106 may be implemented in any application that allows creation and delivery of marketing content to users, including, but not limited to, various applications.

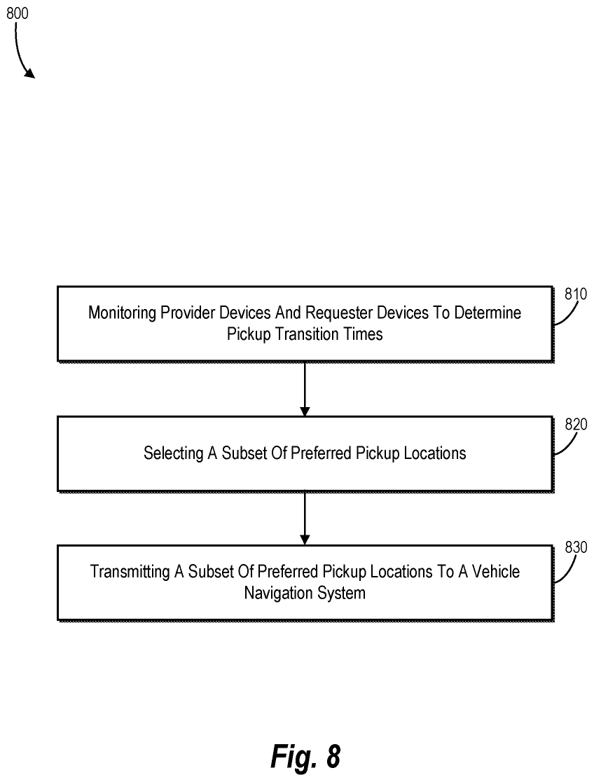

FIGS. 1-7, the corresponding text, and the examples provide a number of different systems, methods, and non-transitory computer readable media for selecting and providing a transportation request to a limited-eligibility provider device. In addition to the foregoing, embodiments can also be described in terms of flowcharts comprising acts for accomplishing a particular result. For example, FIG. 8 illustrates a flowchart of an example sequence of acts in accordance with one or more embodiments.

While FIG. 8 illustrates acts according to some embodiments, alternative embodiments may omit, add to, reorder, and/or modify any of the acts shown in FIG. 8. The acts of FIG. 8 can be performed as part of a method. Alternatively, a non-transitory computer readable medium can comprise instructions, that when executed by one or more processors, cause a computing device to perform the acts of FIG. 8. In still further embodiments, a system can perform the acts of FIG. 8. Additionally, the acts described herein may be repeated or performed in parallel with one another or in parallel with different instances of the same or other similar acts.

FIG. 8 illustrates an example series of acts 800 for determining a subset of preferred pickup locations in accordance with one or more embodiments. As shown, the series of acts 800 includes an act 810 monitoring provider devices and requester devices to determine pickup transition times. In particular, the act 810 can involve monitoring, via one or more servers, provider devices and requester devices corresponding to transportation requests to determine pickup transition times for a plurality of pickup locations by determining, from a provider device, a provider device arrival time at a pickup location corresponding to a transportation request from a requester device; determining a departure time for the transportation request from the provider device or the requester device; and comparing the departure time and the provider device arrival time to determine a pickup transition time.

In addition, the series of acts 800 includes an act 820 of selecting a subset of preferred pickup locations. In particular, the act 820 can involve selecting a subset of preferred pickup locations from the plurality of pickup locations based on the pickup transition times.

In addition, the series of acts 800 includes an act 830 of transmitting a subset of preferred pickup locations to a vehicle navigation system. In particular, the act 830 can involve transmitting, via the one or more servers, one or more of the subset of preferred pickup locations to a vehicle navigation system for navigating provider devices to the one or more of the subset of preferred pickup locations.

In some embodiments, the series of acts 800 includes additional acts wherein selecting the subset of preferred pickup locations comprises utilizing an autonomous vehicle location filter to select the filtered subset, wherein the autonomous vehicle location filter indicates an area accessible to autonomous vehicles.

In some embodiments, the series of acts 800 includes additional acts of comparing the transition time with a threshold transition time to determine a first transition classification for the transportation request.

In some embodiments, the series of acts 800 includes additional acts of determining an additional transition time corresponding to the pickup location for an additional transportation request from an additional requester device; and comparing the additional transition time with the threshold transition time to determine a second transition classification for the additional transportation request; and determining a measure of threshold-length transition pickups for the pickup location based on the first transition classification and the second transition classification.

In some embodiments, the series of acts 800 includes additional acts of selecting the subset of preferred pickup locations by comparing the measure of threshold-length transition pickups corresponding to the pickup location with an additional measure of threshold-length transition pickups corresponding to an additional pickup location.

In some embodiments, the series of acts 800 includes additional acts wherein the pickup transition times corresponds to a first time period and selecting the subset of preferred pickup locations comprises selecting a first subset of preferred pickup locations for the first time period, and further comprising: determining an additional plurality of pickup transition times corresponding to a second time period; and selecting a second subset of preferred pickup locations corresponding to the second time period

In some embodiments, the series of acts 800 includes additional acts of determining a transportation mode corresponding to the transportation request, wherein the transportation mode comprises at least one of a multi-passenger mode or a limited eligibility transportation mode; and selecting the subset of preferred pickup locations based on the pickup transition times and the transportation mode.

In some embodiments, the series of acts 800 includes additional acts of determining a provider device rating associated with the provider device; and selecting the subset of preferred pickup locations from the plurality of pickup locations based on the pickup transition times and the provider device rating.

In some embodiments, the series of acts 800 includes additional acts of determining a number of transportation requests at the pickup location; and selecting the subset of preferred pickup locations based on the number of transportation requests at the pickup location and the pickup transition times.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates, in block diagram form, an exemplary computing device 900 (e.g., the provider device(s) 122, the requester device(s) 112, or the server(s) 102) that may be configured to perform one or more of the processes described above. One will appreciate that the AV transition location system 106 can comprise implementations of the computing device 900, including, but not limited to, the provider device(s) 122, third-party system(s) 132, and/or the server(s) 102. As shown by FIG. 9, the computing device can comprise a processor 902, memory 904, a storage device 906, an I/O interface 908, and a communication interface 910. In certain embodiments, the computing device 900 can include fewer or more components than those shown in FIG. 9. Components of computing device 900 shown in FIG. 9 will now be described in additional detail.

In particular embodiments, processor(s) 902 includes hardware for executing instructions, such as those making up a computer program. As an example, and not by way of limitation, to execute instructions, processor(s) 902 may retrieve (or fetch) the instructions from an internal register, an internal cache, memory 904, or a storage device 906 and decode and execute them.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 904 may be internal or distributed memory.

The computing device 900 includes a storage device 906 includes storage for storing data or instructions. As an example, and not by way of limitation, storage device 906 can comprise a non-transitory storage medium described above. The storage device 906 may include a hard disk drive (“HDD”), flash memory, a Universal Serial Bus (“USB”) drive or a combination of these or other storage devices.

The computing device 900 also includes one or more input or output interface 908 (or “I/O interface 908”), which are provided to allow a user (e.g., requester or provider) to provide input to (such as user strokes), receive output from, and otherwise transfer data to and from the computing device 900. These I/O interface 908 may include a mouse, keypad or a keyboard, a touch screen, camera, optical scanner, network interface, modem, other known I/O devices or a combination of such I/O interface 908. The touch screen may be activated with a stylus or a finger.

The I/O interface 908 may include one or more devices for presenting output to a user, including, but not limited to, a graphics engine, a display (e.g., a display screen), one or more output providers (e.g., display providers), one or more audio speakers, and one or more audio providers. In certain embodiments, interface 908 is configured to provide graphical data to a display for presentation to a user. The graphical data may be representative of one or more graphical user interfaces and/or any other graphical content as may serve a particular implementation.

The computing device 900 can further include a communication interface 910. The communication interface 910 can include hardware, software, or both. The communication interface 910 can provide one or more interfaces for communication (such as, for example, packet-based communication) between the computing device and one or more other computing devices 900 or one or more networks. As an example, and not by way of limitation, communication interface 910 may include a network interface controller (“NIC”) or network adapter for communicating with an Ethernet or other wire-based network or a wireless NIC (“WNIC”) or wireless adapter for communicating with a wireless network, such as a WI-FI. The computing device 900 can further include a bus 912. The bus 912 can comprise hardware, software, or both that connects components of computing device 900 to each other.

FIG. 10 illustrates an example network environment 1000 of the transportation matching system 104. The network environment 1000 includes a client device 1006 (e.g., the provider device(s) 122 or the requester device(s) 112), a transportation matching system 104, and third-party system(s) 132 connected to each other by a network 1004. Although FIG. 10 illustrates a particular arrangement of the client device 1006, the transportation matching system 104, the vehicle subsystem 1008, and the network 1004, this disclosure contemplates any suitable arrangement of client device 1006, the transportation matching system 104, the vehicle subsystem 1008, and the network 1004. As an example, and not by way of limitation, two or more of client device 1006, the transportation matching system 104, and the vehicle subsystem 1008 communicate directly, bypassing network 1004. As another example, two or more of client device 1006, the transportation matching system 104, and the vehicle subsystem 1008 may be physically or logically co-located with each other in whole or in part.

Moreover, although FIG. 10 illustrates a particular number of client devices 1006, transportation matching system 104, vehicle subsystems 1008, and networks 1004, this disclosure contemplates any suitable number of client devices 1006, transportation matching system 104, vehicle subsystems 1008, and networks 1004. As an example, and not by way of limitation, network environment 1000 may include multiple client device 1006, transportation matching system 104, vehicle subsystems 1008, and/or networks 1004.

This disclosure contemplates any suitable network 1004. As an example, and not by way of limitation, one or more portions of network 1004 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1004 may include one or more networks 1004.

Links may connect client device 1006, AV transition location system 106, and vehicle subsystem 1008 to network 1004 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1000. One or more first links may differ in one or more respects from one or more second links.

In particular embodiments, the client device 1006 may be an electronic device including hardware, software, or embedded logic components or a combination of two or more such components and capable of carrying out the appropriate functionalities implemented or supported by client device 1006. As an example, and not by way of limitation, a client device 1006 may include any of the computing devices discussed above in relation to FIG. 9. A client device 1006 may enable a network user at the client device 1006 to access network 1004. A client device 1006 may enable its user to communicate with other users at other client devices 1006.

In particular embodiments, the client device 1006 may include a requester application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 1006 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 1006 one or more Hyper Text Markup Language (“HTML”) files responsive to the HTTP request. The client device 1006 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, transportation matching system 104 may be a network-addressable computing system that can host a transportation matching network. The transportation matching system 104 may generate, store, receive, and send data, such as, for example, user-profile data, concept-profile data, text data, transportation request data, GPS location data, provider data, requester data, vehicle data, or other suitable data related to the transportation matching network. This may include authenticating the identity of providers and/or vehicles who are authorized to provide transportation services through the transportation matching system 104. In addition, the transportation matching system 104 may manage identities of service requesters such as users/requesters. In particular, the transportation matching system 104 may maintain requester data such as driving/riding histories, personal data, or other user data in addition to navigation and/or traffic management services or other location services (e.g., GPS services).

In particular embodiments, the transportation matching system 104 may manage transportation matching services to connect a user/requester with a vehicle and/or provider. By managing the transportation matching services, the transportation matching system 104 can manage the distribution and allocation of resources from vehicle systems and user resources such as GPS location and availability indicators, as described herein.

The transportation matching system 104 may be accessed by the other components of network environment 1000 either directly or via network 1004. In particular embodiments, the transportation matching system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the transportation matching system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1006, or a transportation matching system 104 to manage, retrieve, modify, add, or delete, the information stored in data store.

In particular embodiments, the transportation matching system 104 may provide users with the ability to take actions on various types of items or objects, supported by the transportation matching system 104. As an example, and not by way of limitation, the items and objects may include transportation matching networks to which users of the transportation matching system 104 may belong, vehicles that users may request, location designators, computer-based applications that a user may use, transactions that allow users to buy or sell items via the service, interactions with advertisements that a user may perform, or other suitable items or objects. A user may interact with anything that is capable of being represented in the transportation matching system 104 or by an external system of a third-party system, which is separate from transportation matching system 104 and coupled to the transportation matching system 104 via a network 1004.

In particular embodiments, the transportation matching system 104 may be capable of linking a variety of entities. As an example, and not by way of limitation, the transportation matching system 104 may enable users to interact with each other or other entities, or to allow users to interact with these entities through an application programming interfaces (“API”) or other communication channels.

In particular embodiments, the transportation matching system 104 may include a variety of servers, sub-systems, programs, modules, logs, and data stores. In particular embodiments, the transportation matching system 104 may include one or more of the following:

a web server, action logger, API-request server, relevance-and-ranking engine, content-object classifier, notification controller, action log, third-party-content-object-exposure log, inference module, authorization/privacy server, search module, advertisement-targeting module, user-interface module, user-profile (e.g., provider profile or requester profile) store, connection store, third-party content store, or location store. The transportation matching system 104 may also include suitable components such as network interfaces, security mechanisms, load balancers, failover servers, management-and-network-operations consoles, other suitable components, or any suitable combination thereof. In particular embodiments, the transportation matching system 104 may include one or more user-profile stores for storing user profiles for transportation providers and/or transportation requesters. A user profile may include, for example, biographic information, demographic information, behavioral information, social information, or other types of descriptive information, such as interests, affinities, or location.

The web server may include a mail server or other messaging functionality for receiving and routing messages between the transportation matching system 104 and one or more client devices 1006. An action logger may be used to receive communications from a web server about a user's actions on or off the transportation matching system 104. In conjunction with the action log, a third-party-content-object log may be maintained of user exposures to third-party-content objects. A notification controller may provide information regarding content objects to a client device 1006. Information may be pushed to a client device 1006 as notifications, or information may be pulled from client device 1006 responsive to a request received from client device 1006. Authorization servers may be used to enforce one or more privacy settings of the users of the transportation matching system 104. A privacy setting of a user determines how particular information associated with a user can be shared. The authorization server may allow users to opt in to or opt out of having their actions logged by the transportation matching system 104 or shared with other systems, such as, for example, by setting appropriate privacy settings. Third-party-content-object stores may be used to store content objects received from third parties. Location stores may be used for storing location information received from client devices 1006 associated with users.

In addition, the vehicle subsystem 1008 can include a human-operated vehicle or an autonomous vehicle. A provider of a human-operated vehicle can perform maneuvers to pick up, transport, and drop off one or more requesters according to the embodiments described herein. In certain embodiments, the vehicle subsystem 1008 can include an autonomous vehicle—e.g., a vehicle that does not require a human operator. In these embodiments, the vehicle subsystem 1008 can perform maneuvers, communicate, and otherwise function without the aid of a human provider, in accordance with available technology.

In particular embodiments, the vehicle subsystem 1008 may include one or more sensors incorporated therein or associated thereto. For example, sensor(s) can be mounted on the top of the vehicle subsystem 1008 or else can be located within the interior of the vehicle subsystem 1008. In certain embodiments, the sensor(s) can be located in multiple areas at once—e.g., split up throughout the vehicle subsystem 1008 so that different components of the sensor(s) can be placed in different locations in accordance with optimal operation of the sensor(s). In these embodiments, the sensor(s) can include motion-related components such as an inertial measurement unit (“IMU”) including one or more accelerometers, one or more gyroscopes, and one or more magnetometers. The sensor(s) can additionally or alternatively include a wireless IMU (“WIMU”), one or more cameras, one or more microphones, or other sensors or data input devices capable of receiving and/or recording information relating to navigating a route to pick up, transport, and/or drop off a requester.

In particular embodiments, the vehicle subsystem 1008 may include a communication device capable of communicating with the client device 1006 and/or the AV transition location system 106. For example, the vehicle subsystem 1008 can include an on-board computing device communicatively linked to the network 1004 to transmit and receive data such as GPS location information, sensor-related information, requester location information, or other relevant information.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
monitoring, via one or more computing systems, updates from provider devices and requester devices corresponding to transportation requests to determine pickup transition times for a plurality of pickup locations by:
determining, from a provider device, a provider device arrival time at a pickup location corresponding to a transportation request from a requester device;
determining a departure time for the transportation request from the provider device or the requester device; and
comparing the departure time and the provider device arrival time to determine a pickup transition time;
selecting a subset of preferred pickup locations from the plurality of pickup locations based on the pickup transition times; and
transmitting, via the one or more computing systems, one or more of the subset of preferred pickup locations to a vehicle navigation system for navigating provider devices to the one or more of the subset of preferred pickup locations.

2. The computer-implemented method of claim 1, wherein selecting the subset of preferred pickup locations comprises utilizing an autonomous vehicle location filter to select the filtered subset, wherein the autonomous vehicle location filter indicates an area accessible to autonomous vehicles.

3. The computer-implemented method of claim 1, further comprising comparing the pickup transition time with a threshold transition time to determine a first transition classification for the transportation request.

4. The computer-implemented method of claim 3, further comprising:
determining an additional pickup transition time corresponding to the pickup location for an additional transportation request from an additional requester device;
comparing the additional pickup transition time with the threshold transition time to determine a second transition classification for the additional transportation request; and
determining a measure of threshold-length transition pickups for the pickup location based on the first transition classification and the second transition classification.

5. The computer-implemented method of claim 4, further comprising: selecting the subset of preferred pickup locations by comparing the measure of threshold-length transition pickups corresponding to the pickup location with an additional measure of threshold-length transition pickups corresponding to an additional pickup location.

6. The computer-implemented method of claim 1, wherein the pickup transition times corresponds to a first time period and selecting the subset of preferred pickup locations comprises selecting a first subset of preferred pickup locations for the first time period, and further comprising:
determining an additional plurality of pickup transition times corresponding to a second time period; and
selecting a second subset of preferred pickup locations corresponding to the second time period.

7. The computer-implemented method of claim 1, further comprising:
determining a transportation mode corresponding to the transportation request, wherein the transportation mode comprises at least one of a multi-passenger mode or a limited eligibility transportation mode; and
selecting the subset of preferred pickup locations based on the pickup transition times and the transportation mode.

8. The computer-implemented method of claim 1, further comprising:
determining a provider device rating associated with the provider device; and
selecting the subset of preferred pickup locations from the plurality of pickup locations based on the pickup transition times and the provider device rating.

9. The computer-implemented method of claim 1, further comprising:
determining a number of transportation requests corresponding to the pickup location; and
selecting the subset of preferred pickup locations based on the number of transportation requests corresponding to the pickup location and the pickup transition times.

10. A system comprising:
at least one processor; and
a non-transitory computer-readable medium comprising instructions that, when executed by the at least one processor, to cause the system to:
monitor, via one or more servers, updates from provider devices and requester devices corresponding to transportation requests to determine pickup transition times for a plurality of pickup locations by:
determining, from a provider device, a provider device arrival time at a pickup location corresponding to a transportation request from a requester device;
determining a departure time for the transportation request from the provider device or the requester device; and
comparing the departure time and the provider device arrival time to determine a pickup transition time;
select a subset of preferred pickup locations from the plurality of pickup locations based on the pickup transition times; and
transmit, via the one or more servers, one or more of the subset of preferred pickup locations to a vehicle navigation system for navigating provider devices to the one or more of the subset of preferred pickup locations.

11. The system of claim 10, wherein the instructions further cause the system to:
select the subset of preferred pickup locations utilizing an autonomous vehicle location filter to select the filtered subset, wherein the autonomous vehicle location filter indicates area accessible to autonomous vehicles.

12. The system of claim 10, wherein the instructions further cause the system to:
determine an additional pickup transition time corresponding to the pickup location for an additional transportation request from an additional requester device;
combine the pickup transition time and the additional pickup transition time to determine an expected pickup transition time at the pickup location; and
select the subset of preferred pickup locations by comparing the expected pickup transition time with a threshold transition time.

13. The system of claim 10, wherein the pickup transition times corresponds to a first time period, and the instructions further cause the system to:
select the subset of preferred pickup locations by selecting a first subset of preferred pickup locations for the first time period;
determine an additional plurality of pickup transition times corresponding to a second time period; and
select a second subset of preferred pickup locations corresponding to the second time period.

14. The system of claim 10, wherein the instructions further cause the system to:
determine a transportation mode corresponding to the transportation request, wherein the transportation mode comprises at least one of a multi-passenger mode or a limited eligibility transportation mode; and
select the subset of preferred pickup locations based on the pickup transition times and the transportation mode.

15. The system of claim 10, wherein the instructions further cause the system to:
determine a provider device rating associated with the provider device; and
select the subset of preferred pickup locations from the plurality of pickup locations based on the pickup transition times and the provider device rating.

16. The system of claim 10, wherein the instructions further cause the system to:
determine a number of transportation requests at the pickup location; and
select the subset of preferred pickup locations based on the number of transportation requests at the pickup location and the pickup transition times.

17. A non-transitory computer readable storage medium comprising instructions that, when executed by at least one processor, cause the at least one processor to:
monitor, via one or more servers, updates from provider devices and requester devices corresponding to transportation requests to determine pickup transition times for a plurality of pickup locations by:
determining, from a provider device, a provider device arrival time at a pickup location corresponding to a transportation request from a requester device;
determining a departure time for the transportation request from the provider device or the requester device; and
comparing the departure time and the provider device arrival time to determine a pickup transition time;
select a subset of preferred pickup locations from the plurality of pickup locations based on the pickup transition times; and
transmit, via the one or more servers, one or more of the subset of preferred pickup locations to a vehicle navigation system for navigating provider devices to the one or more of the subset of preferred pickup locations.

18. The non-transitory computer readable storage medium of claim 17, further comprising instructions that, when executed by the at least one processor, cause the at least one processor to:
select the subset of preferred pickup locations utilizing an autonomous vehicle location filter to select the filtered subset, wherein the autonomous vehicle location filter indicates area accessible to autonomous vehicles.

19. The non-transitory computer readable storage medium of claim 17, further comprising instructions that, when executed by the at least one processor, cause the at least one processor to:
determine an additional pickup transition time corresponding to the pickup location for an additional transportation request from an additional requester device;
combine the pickup transition time and the additional pickup transition time to determine an expected pickup transition time at the pickup location; and
select the subset of preferred pickup locations by comparing the expected pickup transition time with a threshold transition time.

20. The non-transitory computer readable storage medium of claim 17, further comprising instructions that, when executed by the at least one processor, cause the at least one processor to:
determine a transportation mode corresponding to the transportation request, wherein the transportation mode comprises at least one of a multi-passenger mode or a limited eligibility transportation mode; and
select the subset of preferred pickup locations based on the pickup transition times and the transportation mode.
